(19) United States
(12) Patent Application Publication
(10) Pub. No.: US 2007/0002379 A1
(43) Pub. Date: Jan. 4, 2007

(54) Printing system and printing method

(75) Inventor: Naotoshi Momose, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/476,612

(22) Filed: Jun. 29, 2006

(30) Foreign Application Priority Data
Jun. 30, 2005 (JP) 2005-192429
Dec. 21, 2005 (JP) 2005-368620

(51) Int. Cl. G06K 15/00

(52) U.S. Cl. 358/1.18; 358/1.12

(57) ABSTRACT

A printing system for printing a poster image through marginless printing without cutting paper. A printing system magnifies a first original image by a predetermined magnification rate to generate a second original image. The printing system calculates the area of a second divisional image laid out in a printing area (during marginless printing) based on a first divisional image using the magnification rate. The printing system cuts out the second divisional image from the second original image in a manner that the second divisional image includes parts of the surrounding divisional images.

### CROSS-REFERENCE TO RELATED APPLICATIONS

This application is based upon and claims the benefit of priority from the prior Japanese Patent Applications No. 2005-192429, filed on Jun. 30, 2005, and No. 2005-368620, filed on Dec. 21, 2005, the entire contents of which are incorporated herein by reference.

### BACKGROUND OF THE INVENTION

The present invention relates to a printing system and a printing method, and more particularly, to a system and a method for printing a poster image through marginless printing.

A poster image is conventionally printed according to the procedure described below. First, an image that is to be printed (hereafter referred to as an “original image”) is divided (in horizontal and vertical directions) into a certain number of divisional images. Next, each of the divisional images is printed on a predetermined paper. After cutting off the edges (margins on the four sides) from each paper, the papers are joined together with tape to complete a poster. This method enables the printing of an image that is larger than the largest paper size with a printer.

However, because this method requires the papers to be cut, the papers are not effectively used and parts of the papers are wasted. This reduces the size of the ultimately completed poster. Further, the paper cutting is burdensome, and it is difficult to accurately cut the edges of the papers along a straight line. The accuracy of the paper cutting operation affects the appearance of the completed poster. For such reasons, it is difficult to print a poster.

To solve this problem, Japanese Laid-Open Patent Publication No. 2003-114771 describes a method for printing divisional images through marginless printing. A paper used for marginless printing has no margins on its four sides. Thus, marginless printing eliminates the need for the paper cutting operation.

However, marginless printing is performed by printing an image over an area extending beyond the edge of a paper so that margins or not produced when a mechanical misalignment occurs in the printer. As a result, divisional images printed on papers through marginless printing are not continuous when the papers are joined together.

This problem will now be described in detail with reference to FIGS. 1 and 2.

As shown in FIG. 1, an original image Img, which is the image that is to be printed as a poster, is divided into, for example, four (2 by 2) divisional images Div1, Div2, Div3, and Div4. Each of the divisional images is printed on a paper P through marginless printing. FIG. 2 is a schematic diagram showing the completed state of a poster printed through marginless printing.

As shown in FIG. 1, the divisional image Div1 is printed in a printing area PA, which is set by adding a predetermined overhanging amount (area shown by slanted lines) to the paper P. Thus, the periphery of the divisional image Div1 is not printed on the paper P. As a result, the divisional images Div1, Div2, Div3, and Div4 printed on the papers P are not continuous as shown in FIG. 2 when the papers P are joined together. In other words, the image of the completed poster differs from the original image Img. For the reasons described above, conventional marginless printing is not practical.

### SUMMARY

The present invention provides a printing system and a printing method for printing a poster image through marginless printing without requiring paper cutting.

One aspect of the present invention is a printing system for forming a poster image corresponding to a first original image by performing marginless printing on plural sheets of paper, the paper having a predetermined size. The printing system includes a printing area setting unit for setting a printing area by magnifying the size of the paper by a predetermined magnification rate. An image generating unit magnifies the first original image by the predetermined magnification rate to generate a second original image and for generating a plurality of divisional images from the second original image using the first original image, a division number by which the first original image is divided, and the magnification rate. An image layout unit lays out each of the plurality of divisional images in the printing area. A printing control unit generates printing data of each of the plurality of divisional images laid out in the printing area so that the center of each of the divisional images is substantially aligned with the center of the paper to which the divisional image is to be printed.

The magnification rate may be set so that a magnified amount of each of the plurality of divisional images that is magnified by the magnification rate is less than or equal to the overhang amount but greater than or equal to zero.

Another aspect of the present invention is a printing system for forming a poster image corresponding to a first original image by performing marginless printing on plural sheets of paper, the paper having a predetermined size. The printing system includes a printing area setting unit for setting a printing area by magnifying the size of the paper by a first magnification rate. An image generating unit magnifies the first original image by a second magnification rate, which is less than the first magnification rate, to generate a second original image and for generating a plurality of divisional images from the second original image using the first original image, a division number by which the first original image is divided, and the first magnification rate. An image layout unit lays out each of the plurality of divisional images in the printing area. A printing control unit generates printing data of each of the plurality of divisional images laid out in the printing area so that the center of each of the divisional images is substantially aligned with the center of the paper to which the divisional image is to be printed. The second magnification rate is set to be less than the first magnification rate within a range enabling each of the plurality of divisional images to be generated from the second original image.

The image generating unit may divide the first original image by the division number to generate a plurality of first divisional images and magnifies each of the plurality of first divisional images by the first magnification rate to generate a plurality of second divisional images respectively corresponding to the plurality of divisional images from the second original image.

The printing area setting unit may calculate printing position information including the size of the printing area and first offset coordinates indicating the position of the printing area. The image generating unit may calculate layout information including the size of each of the plurality of divisional images and second offset coordinates indicating the position of each of the plurality of divisional images. The image layout unit may lay out each of the plurality of divisional images in the printing area based on the printing position information and the layout information.

The printing system may include a computer and a printer connected to the computer. The computer may include a printer driver for controlling operation of the printer and an application for aiding generation of the poster image. The application may function as part of the image generating unit and generating the second original image from the first original image using the first original image and the second magnification rate. The printer driver may function as part of the image generating unit and generating the plurality of divisional images from the second original image using the first original image, the division number, and the first magnification rate.

The printer driver further may function as the printing area setting unit, the image layout unit, and the printing control unit.

The printer driver may calculate the size and resolution of the second original image based on the division number, the size of the paper, the second magnification rate, and a printing resolution set for the printer. The application may retrieve the size and the resolution of the second original image from the printer driver to generate the second original image.

The poster image may be printed so as to form a single poster image with plurality sheets of the paper, with at least one of the plural sheets of paper having a side on which a margin is formed and a side on which no margin is formed.

A further aspect of the present invention is a method for forming a poster image corresponding to a first original image by performing marginless printing on plural sheets of paper, the paper having a predetermined size. The method includes setting a printing area by magnifying the size of the paper by a predetermined magnification rate, magnifying the first original image by the predetermined magnification rate to generate a second original image, dividing the first original image by a division number that is greater than or equal to two to generate a plurality of first divisional images, magnifying each of the plurality of first divisional images by the magnification rate to generate a plurality of second divisional images from the second original image, laying out each of the plurality of second divisional images in the printing area, and generating printing data for each of the plurality of divisional images laid out in the printing area so that the center of each of the divisional images is substantially aligned with the center of the paper to which the divisional image is to be printed.

A further aspect of the present invention is an image processor. The image processor includes an original image retrieval unit for retrieving an original image. An output image generation unit generates a predetermined number of output images from the retrieved original image. A printing control unit prints each of the output images on a predetermined sheet of paper, with each output image being larger than the sheet of paper and having a center that is substantially aligned with the center of the sheet of paper. Each of the output images corresponds to a divisional image generated by dividing the original image by a predetermined number and includes the corresponding divisional image.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing conventional marginless printing;

FIG. 2 is a schematic diagram showing the completed state of a poster printed through conventional marginless printing;

FIG. 3 is a schematic functional block diagram of a printing system according to a first embodiment of the present invention;

FIG. 4 is a schematic block diagram of a computer included in the printing system of FIG. 3;

FIG. 5 is a schematic diagram describing a calculation method used in the printing system of FIG. 3 for calculating printing position information;

FIG. 6 is a schematic diagram describing a calculation method used in the printing system of FIG. 3 for calculating layout information;

FIG. 7 is a flowchart showing a poster formation process performed by the printing system of FIG. 3;

FIG. 8 is a schematic diagram showing the printing state of marginless printing performed by the printing system of FIG. 3;

FIG. 9 is a schematic diagram showing the completed state of a poster printed through the printing system of FIG. 3;

FIG. 10 is a schematic diagram showing marginless printing according to a second embodiment of the present invention;

FIG. 11 is a schematic diagram showing marginless printing according to a third embodiment of the present invention;

FIG. 12 is a schematic diagram describing marginless printing according to a fourth embodiment of the present invention;

FIG. 13 is a flowchart showing a poster formation process in the fourth embodiment; and

FIG. 14 is a schematic diagram showing an example using another division number.

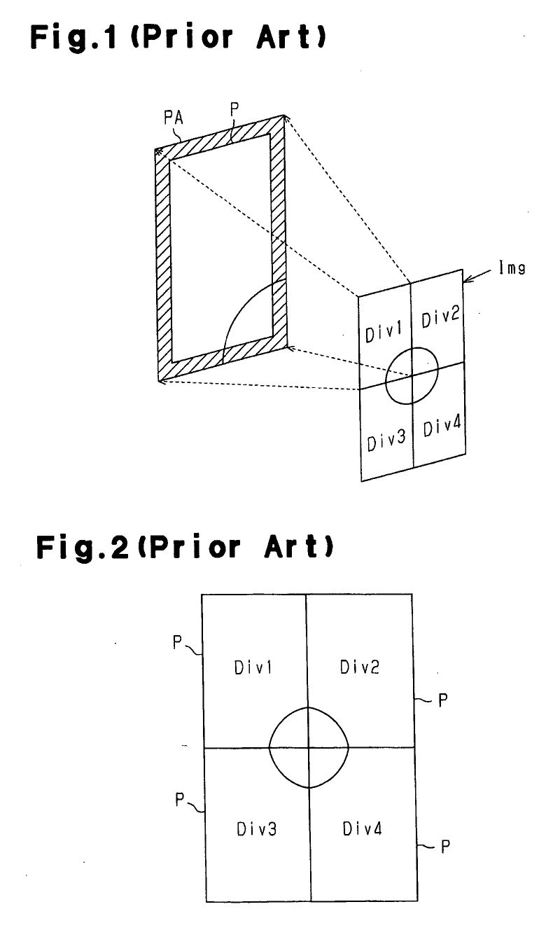

### DETAILED DESCRIPTION OF THE PREFERRED EMBODIMENTS

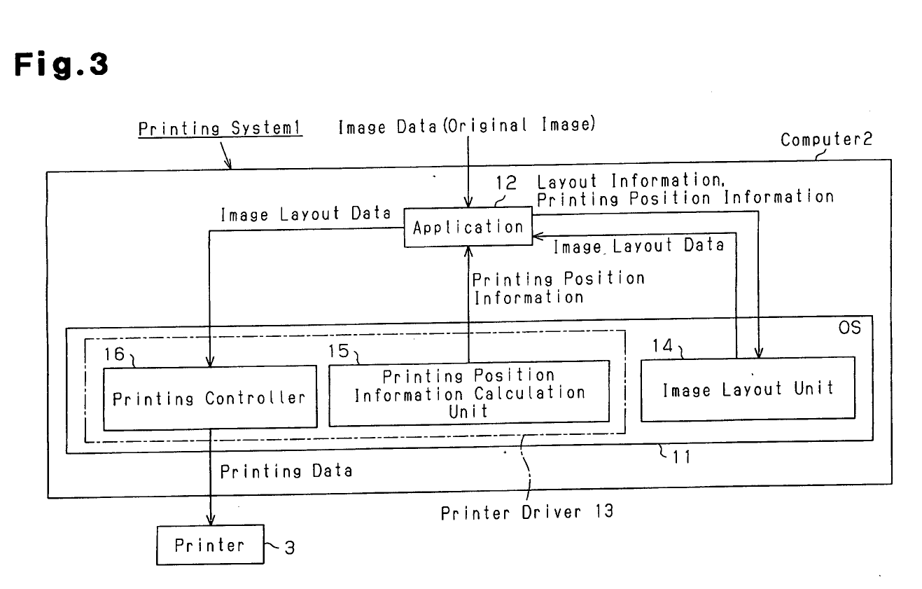

A printing system 1 according to a first embodiment of the present invention will now be described with reference to FIGS. 3 to 9.

FIG. 3 is a schematic functional block diagram of a printing system 1 according to a first embodiment of the present invention. The printing system 1 includes a computer 2 (An image processor) and a printer 3. The printer 3 is connected to the computer 2. In the first embodiment, the computer 2 may be, for example, a personal computer, and the printer 3 may be, for example, an inkjet color printer.

An OS (operating system) 11 and an application (application program) 12 are installed in the computer 2. The OS 11 centrally controls the entire operation of the computer 2. The application 12 operates together with the OS 11. Further, a printer driver (printer driver program) 13 is incorporated in the computer 2. The printer driver 13 operates together with the OS 11.

The application 12 is software for printing posters. The application 12 receives image data of a first original image, which is the image that is to be printed as a poster, from an external device (not shown). The application 12 then divides the first original image by a certain division number to generate a plurality of first divisional images, each of which will be printed through marginless printing. The division number of the first original image is determined in accordance with the size of a poster that is to be printed.

The application 12 retrieves printing position information of each first divisional image from the printer driver 13. The printing position information relates to a printing area in which the first divisional image is printed through marginless printing. The application 12 magnifies the first divisional image based on the printing position information and calculates the size of a second divisional image in correspondence with the size of the printing area as layout information. The application 12 then lays out the second divisional image in the printing area based on the layout information and the printing position information.

In the first embodiment, the application 12 lays out the second divisional image using an API (application program interface) included in an image layout unit 14 of the OS 11. The image layout unit 14 uses a function for copying bitmap data of a first size into an area of a second size (e.g., the StretchBlt function in the Windows (registered trademark) system). The application 12 lays out the second divisional image into the printing area using this function. The application 12 then provides the printer driver 13 with image data (image layout data) of the second divisional image laid out in the printing area.

The printer driver 13 includes a printing position information calculation unit 15 and a printing controller 16. The printing position information calculation unit 15 calculates the printing position information. The printing controller 16 converts the image layout data, which is received from the application 12, into printing data, which is processable by the printer 3. The printing controller 16 then transfers the printing data to the printer 3. Although not shown, the printing controller 16 includes a rasterize unit, a color conversion unit, a half toning unit, and a microweave unit. The rasterize unit generates RGB (red, green, and blue) data from character and draw data. The color conversion unit converts the RGB data into CMYK (cyan, magenta, yellow, and black) data corresponding to ink colors set in the printer 3. The half toning unit converts the CMYK data expressed in halftones into dot data expressed by the formation or non-formation of dots. The microweave unit reorders the dot data in the order in which the data is to be transferred to the printer 3. The printing controller 16 transfers a predetermined command, including the data (printing data) resulting from the microweave processing, to the printer 3. Based on the command, the printer 3 performs marginless printing of the second divisional image on a predetermined paper fed to the printer 3.

In the printing system 1 described above, the printer. driver 13 functions as a printing area setting unit, a printing control unit and an output image generation unit, and the application 12 functions as an image generating unit and an original image retrieval unit. The application 12 may also have the function of the image layout unit 14.

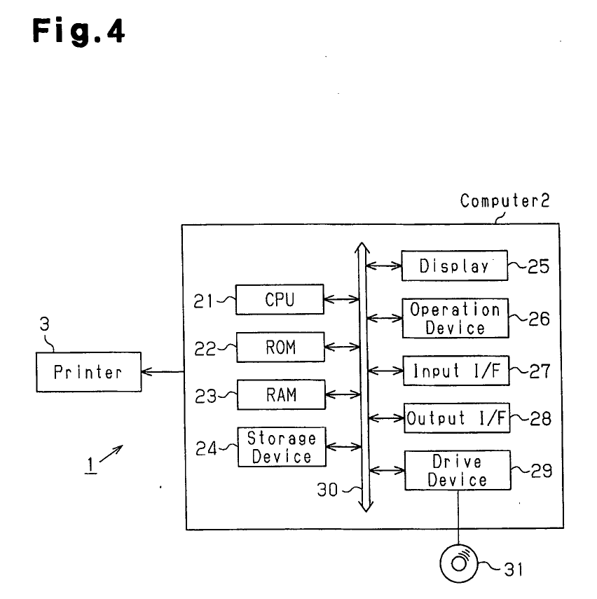

FIG. 4 is a block diagram showing the hardware structure of the computer 2. The computer 2 includes a CPU 21, a ROM 22, a RAM 23, a storage device 24, a display 25, an operation device 26, an input I/F (interface) 27, an output I/F 28, and a drive device 29. These devices are connected to one another by a bus 30.

The ROM 22 stores programs and data executed or used by the CPU 21. The CPU 21 reads programs or data stored in the ROM 22 or the storage device 24 and writes the programs or data to the RAM 23 when necessary. The CPU 21 operates using the RAM 23 as its work area. The storage device 24 stores printer driver programs for enabling the OS 11, the application 12, and the computer 2 to operate as the printer driver 13.

The display 25, which includes, for example, an LCD (liquid crystal display), and is used to display various images on its screen. The operation device 26, which includes a keyboard and a mouse, is used to input user requests and instructions or parameters. The input I/F 27 controls communication (e.g., input of image data) between the computer 2 and an external device (not shown) . The output I/F 28 controls communication (e.g., output of printing data) between the computer 2 and the printer 3.

The programs and data executed or used by the CPU 21 are provided, for example, from a storage medium 31. The drive device 29 drives the storage medium 31 to access the programs or data in the storage medium 31. The drive device 29 reads programs or data from the storage medium 31 and stores the read data into the storage device 24. Examples of the storage medium 31 are media including optical discs (such as a CD-ROM and a DVD-ROM), magneto-optical discs (such as an MO and an MD), and media or disk devices storing programs uploaded or downloaded via communication media. The application 12 and the printer driver 13 of the first embodiment are also provided from the storage medium 31.

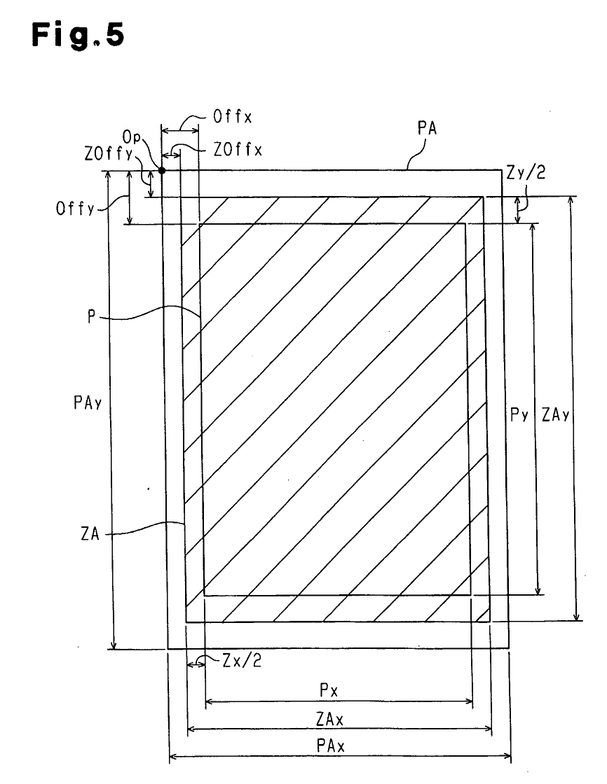

The method for calculating the printing position information will now be described with reference to FIG. 5.

The printing position information calculation unit 15 lays out a second divisional image, and calculates sizes ZAx and ZAy (dots) of a printing area ZA, in which the second divisional image is printed through marginless printing, and offset coordinates ZOffx and ZOffy (dots) indicating the position of the printing area ZA.

More specifically, the printing position information calculation unit 15 calculates the sizes ZAx and ZAy and the offset coordinates ZOffx and ZOffy of the printing area ZA based on paper sizes Px and Py (dots) and an magnification rate ER (%), which is expressed as magnified amounts Zx and Zy by which a first divisional image is magnified to generate the second divisional image. The magnification rate ER is set at a value greater than or equal to zero based on an overhang amount for marginless printing that takes into account mechanical misalignment (e.g., paper skew) of the printer 3. In the first embodiment, the magnification rate ER satisfies the condition of 0<magnified amounts Zx and Zy<overhang amount. In FIG. 5, an area PA is obtained by adding the above overhang amount to the area of the paper P, which is expressed using the paper sizes Px and Py.

The magnified amounts Zx and Zy (dot) are expressed using the paper sizes Px and Py and the magnification rate ER as shown below.
Zx=Px*ER/100
Zy=Py*ER/100

As a result, the sizes ZAx and ZAy of the printing area ZA are calculated by adding the magnified amounts Zx and Zy to the paper sizes Px and Py as shown below.
ZAx=Px+Zx
ZAy=Py+Zy

Further, the offset coordinates ZOffx and ZOffy are calculated using offset coordinates Offx and Offy (dots) indicating the position of the paper P in the printing area ZA and the magnified amounts Zx and Zy as shown below.
ZOffx=Offx−Zx/2
ZOffy=Offy−Zy/2

The offset coordinates Offx and Offy indicate the relative position of the paper P to an origin point position Op of the area PA (the left top position of the area PA in FIG. 5). In other words, the offset coordinates ZOffx and ZOffy indicate the relative position of the printing area ZA to the origin point position Op.

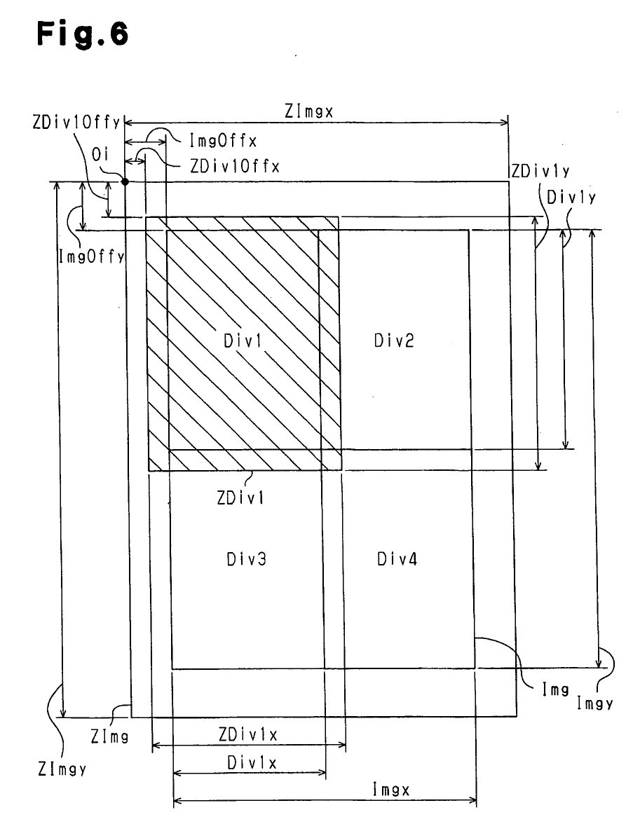

The method for calculating the layout information will now be described with reference to FIG. 6.

In the first embodiment, the division number Nd of the first original image Img is set at 4 as shown in FIG. 6. More specifically, a division number Ndx in the horizontal direction is set at 2 and a division number Ndy in the vertical direction is set at 2. Thus, the first original image Img is divided into four first divisional images Div1, Div2, Div3, and Div4. As one example, layout information of the first divisional image Div1 will be calculated here.

The application 12 calculates, as layout information, sizes ZDiv1x and ZDiv1y (dots) of the second divisional image ZDiv1, which is laid out in the printing area ZA (refer to FIG. 5) and offset coordinates ZDiv1Offx and ZDiv1Offy (dots) indicating the position of the second divisional image ZDiv1.

More specifically, the application 12 calculates the sizes ZDiv1x and ZDiv1y and the offset coordinates ZDiv1Offx and ZDiv1Offy of the second divisional image ZDiv1 based on the magnification rate ER, the division numbers Ndx and Ndy, and sizes ZImgx and ZImgy (dots) of a second original image ZImg obtained by magnifying the first original image Img.

The size ratio of the second original image ZImg to the first original image Img is expressed as (100+ER) % using the magnification rate ER. Accordingly, sizes Imgx and Imgy (dots) of the first original image Img are expressed as shown below.
Imgx=ZImgx*100/(ER+100)
Imgy=ZImgy*100/(ER+100)

Further, sizes Div1x and Div1y (dots) of the first divisional image Div1 are expressed using the sizes Imgx and Imgy of the first original image Img obtained from the above expression and the division numbers Ndx and Ndy as shown below.
Div1x=Imgx/Ndx
Div1y=Imgy/Ndy

As a result, the sizes ZDiv1x and ZDiv1y of the second divisional image ZDiv1 are calculated by adding an image corresponding to the magnified amounts Zx and Zy (refer to FIG. 5) to the sizes Div1x and Div1y of the first divisional image Div1 as shown below.
ZDiv1x=Div1x+Div1x*ER/100
ZDiv1y=Div1y+Div1y*ER/100

Further, the offset coordinates ZDiv1Offx and ZDiv1Offy of the second divisional image ZDiv1 are calculated using the offset coordinates ImgOffx and ImgOffy (dots) of the first original image Img as shown below.
ZDiv1Offx=ImgOffx−(Div1x*ER/100)/2
ZDiv1Offy=ImgOffy−(Div1y*ER/100)/2

In the above expression, the offset coordinates ImgOffx and ImgOffy of the first original image Img are expressed as shown below.
ImgOffx=(ZImgx−Imgx)/2
ImgOffy=(ZImgy−Imgy)/2

The offset coordinates ImgOffx and ImgOffy indicate the relative position of the first original image Img to an origin point position Oi of the second original image ZImg. In other words, the offset coordinates ZDiv1Offx and ZDiv1Offy indicate the relative position of the second divisional image ZDiv1 to the origin point position Oi.

Although the calculation method for the first divisional image Div1 is described above, layout information of each of the second divisional images ZDiv2, ZDiv3, and ZDiv4 respectively corresponding to the other first divisional images Div2, Div3, and Div4 is calculated in the same manner as described above.

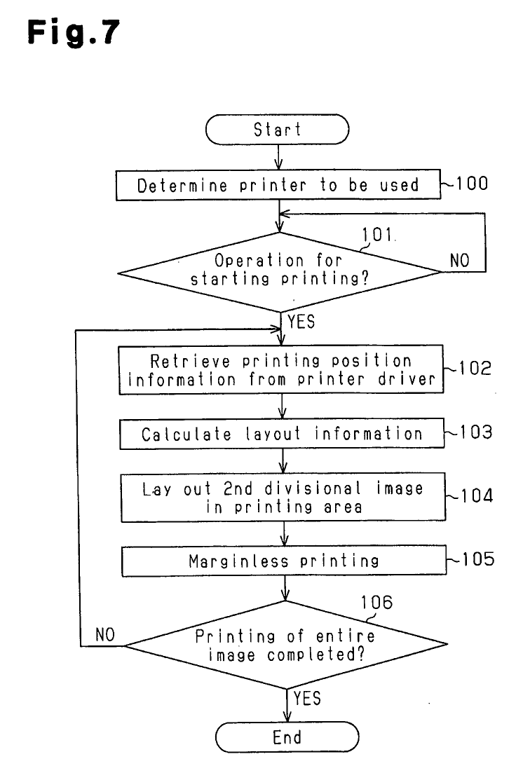

The poster printing process performed by the application 12 of the printing system 1 of FIG. 3 will now be described with reference to FIG. 7.

The application 12 first determines the printer 3 (more specifically, the printer driver 13) that is used to print a poster (step S100) . The application 12 then determines whether a printing starting operation for starting printing of a poster has been performed by a user (step S101).

When the printing starting operation has been performed, the application 12 retrieves printing position information for performing marginless printing of the second divisional image ZDiv1 (the sizes ZAx and ZAy and the offset coordinates ZOffx and ZOffy of the printing area ZA) from the printer driver 13 (step S102).

The application 12 generates the second original image ZImg from the first original image Img in accordance with the magnification rate ER and calculates layout information of the second divisional image ZDiv1 (the sizes ZD1x and ZD1y and the offset coordinates ZDiv1Offx and ZDiv1Offy of the second divisional image ZDiv1) that is to be cut out from the second original image ZImg (step S103).

The application 1.2 lays out the second divisional image ZDiv1 in the printing area ZA based on the layout information and the printing position information using the function of the image layout unit 14 (step S104). The application 12 then instructs the printer 3 to perform marginless printing (step S105). More specifically, the application 12 provides image data (image layout data) of the second divisional image ZDiv1 corresponding to the printing area ZA to the printer driver 13. As a result, the printing data is provided to the printer 3 via the printer driver 13, and the printer 3 performs marginless printing.

The application 12 then determines whether marginless printing of all the second divisional images ZDiv1, ZDiv2, ZDiv3, and ZDiv4 corresponding to the division number Nd has been completed (step S106) . When marginless printing of all the second divisional images ZDiv1, ZDiv2, ZDiv3, and ZDiv4 has been completed, the application 12 ends the poster printing process. When the marginless printing has not been completed, the application 12 repeats steps S102 to S106.

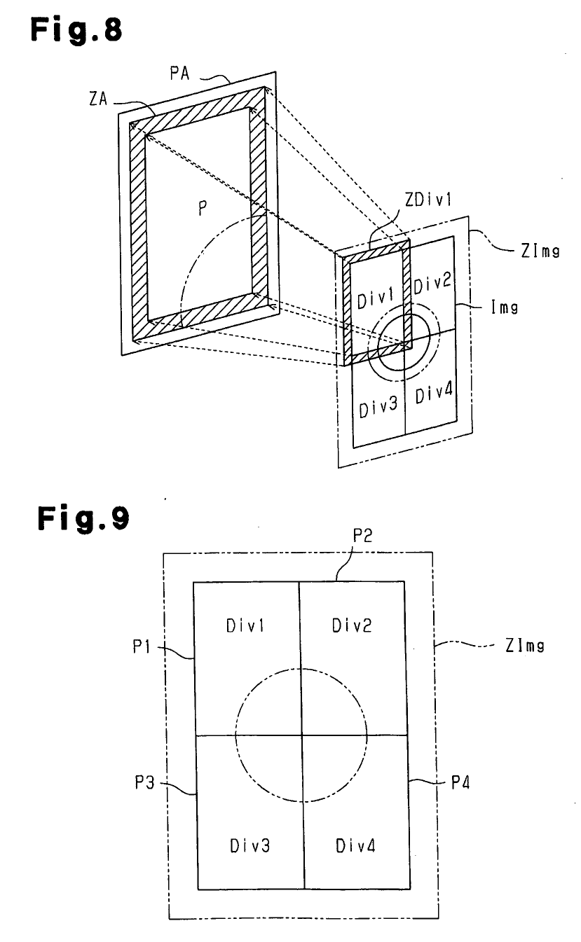

FIG. 8 is a schematic diagram showing the printing state of the second divisional image ZDiv1. FIG. 9 is a schematic diagram showing the completed state of the poster that is formed by joining papers P1, P2, P3, and P4 on which the second divisional images ZDiv1, ZDiv2, ZDiv3, and ZDiv4 are printed respectively. As shown in FIG. 8, the second divisional image ZDiv1 laid out in the printing area ZA is cut out from the second original image ZImg in a manner overlapping the other three first divisional images Div2, Div3, and Div4 surrounding the first divisional image Div1. This ensures that the printing area ZA of the second divisional image ZDiv1 includes an overhanging part (shown by slanted lines in FIG. 11) of the image that extends beyond the edge of the paper P. In this case, the poster image is continuous as shown in FIG. 9 when the papers Pl, P2, P3, and P4 are joined together.

The printing system 1 of the first embodiment has the advantages described below.

(1) The second divisional images ZDiv1, ZDiv2, ZDiv3, and ZDiv4 are generated by magnifying the corresponding first divisional images Div1, Div2, Div3, and Div4 in accordance with the magnification rate ER. Each of the second divisional images ZDiv1, ZDiv2, ZDiv3, and ZDiv4 not only includes the corresponding one of the first divisional images Div1, Div2, Div3, and Div4 but also includes parts of the surrounding first divisional images. This ensures that the printing area ZA of each of the second divisional images ZDiv1, ZDiv2, ZDiv3, and ZDiv4 includes an overhanging part of the image that extends beyond the edge of the paper P. Accordingly, the poster image is continuous when the papers P1, P2, P3, and P4 are joined together, and margins are not produced.

(2) The poster image is printed through marginless printing. Thus, the edges of the papers P1, P2, P3, and P4 do not need to be cut off. This enables a poster to be easily formed and significantly reduces the workload required for completing a poster. Further, papers are not wasted. Since burdensome paper cutting is not necessary, anyone can make a poster having an aesthetic appearance.

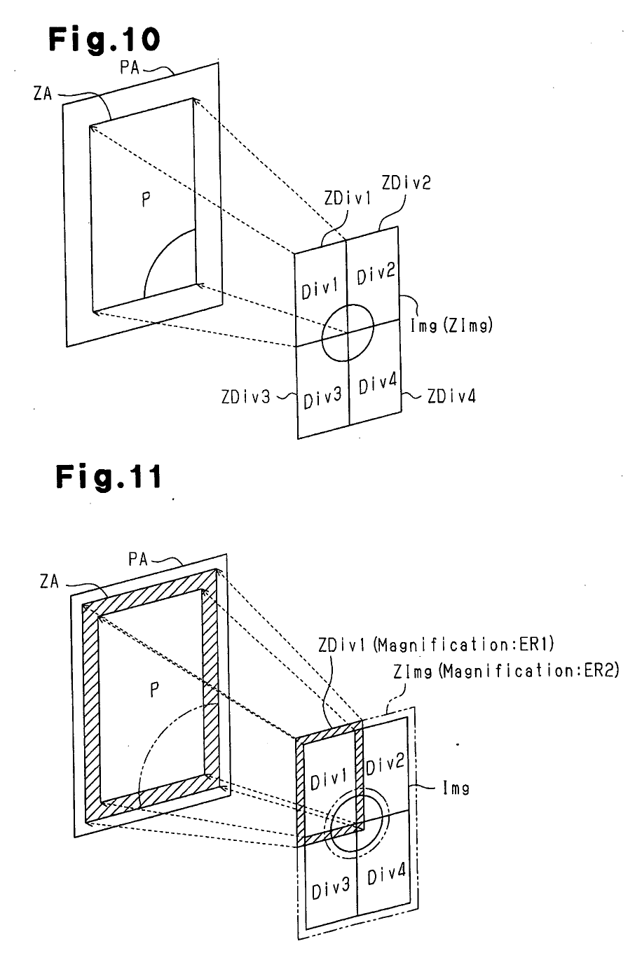

A second embodiment of the present invention will be described with reference to FIG. 10. The second embodiment will be described focusing on differences from the first embodiment.

In the second embodiment, the magnification rate ER is set at 0. More specifically, as shown in FIG. 10, the printing area ZA matches with the area of a paper P, a second original image ZImg is identical to a first original image Img, and second divisional images ZDiv1, ZDiv2, ZDiv3, and ZDiv4 are identical to first divisional images Div1, Div2, Div3, and Div4, respectively. In this case, marginless printing does not produce any overhanging area that extends beyond the edge of the paper P in which an image part is printed. Accordingly, the entire first original image Img is used as a poster image.

A third embodiment of the present invention will now be described with reference to FIG. 11. The third embodiment will be described focusing on differences from the first embodiment.

In the third embodiment, as shown in FIG. 11, a first magnification rate ER1 is used to magnify first divisional images Div1, Div2, Div3, and Div4 and generate second divisional images ZDiv1, ZDiv2, ZDiv3, and ZDiv4. Further, a second magnification rate ER2 is used to magnify a first original image Img and generate a second original image ZImg from which the second divisional images ZDiv1, ZDiv2, ZDiv3, and ZDiv4 are cut out. The second magnification rate ER2 is set smaller than the first magnification rate ER1 within a range that enables the second divisional images ZDiv1, ZDiv2, ZDiv3, and ZDiv4 to be cut out from the second original image ZImg. Each of the second divisional images ZDiv1, ZDiv2, ZDiv3, and ZDiv4 and the printing area ZA is magnified with the same magnification rate, that is, the first magnification rate ER1. In the third embodiment, parts of the image that are not used during marginless printing are less as compared with the first embodiment. Further, marginless printing is less likely to generate margins as compared with the second embodiment.

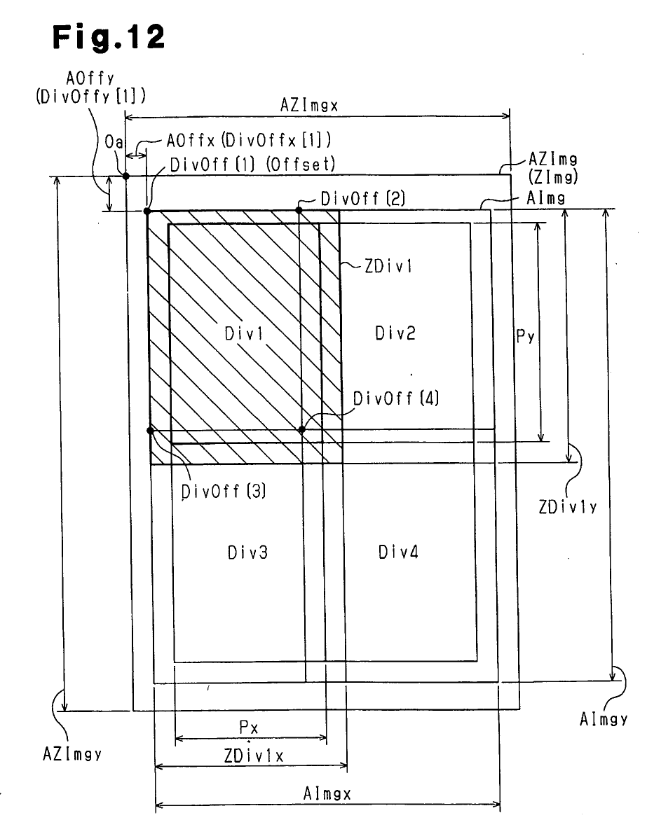

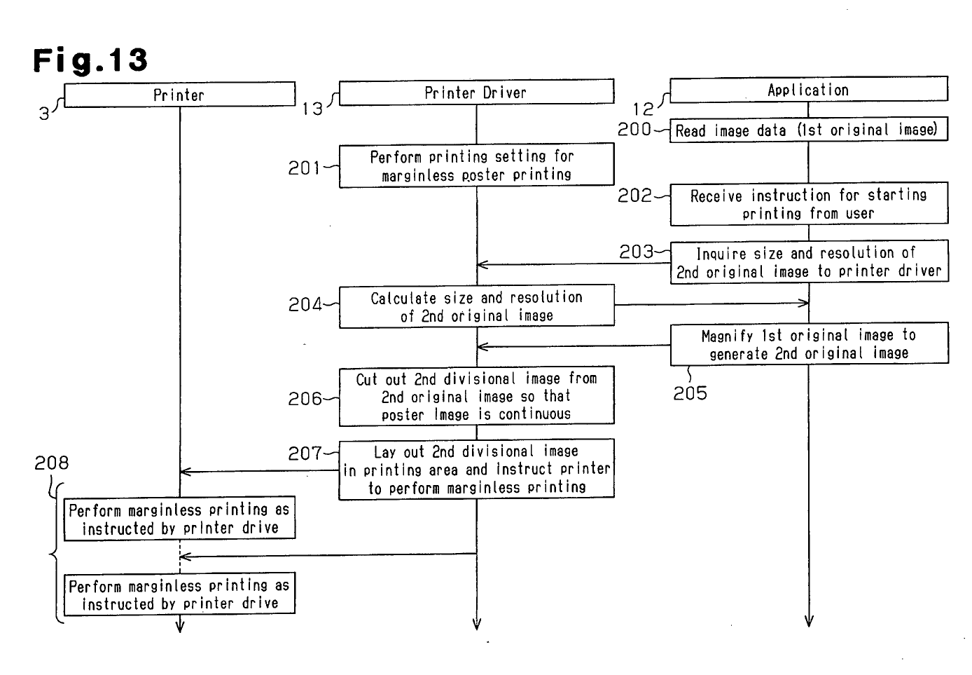

A fourth embodiment of the present invention will now be described with reference to FIGS. 12 and 13. The fourth embodiment will be described focusing on differences from the first embodiment.

In the fourth embodiment, a printer driver 13 generates second divisional images from a second original image, and lays out each second divisional image in a printing area.

As shown in FIG. 13, an application 12 reads image data (first original image) specified by the user in step S200.

In step S201, the printer driver 13 performs printing setting for poster printing through marginless printing in accordance with an instruction from the user. More specifically, the printer driver 13 performs setting of various items including print image quality, paper size, division number, and marginless printing mode.

In step S202, the application 12 accepts a printing starting operation instructed by the user.

In step S203, the application 12 inquires to the printer driver 13 the size and the resolution of each second original image to be generated by magnifying an image, or first image, required to printing a poster image.

In step S204, the printer driver 13 calculates the size and the resolution of each second original image inquired by the application 12. The processing in step S204 will now be described in detail with reference to FIG. 12. In the fourth embodiment, the first original image is divided into four (2 by 2).

In step S204 described above, the printer driver 13 calculates sizes AZImgx and AZImgy (dots) and resolutions ARx and ARy (in dpi) of a second original image AZImg. More specifically, the printer driver 13 calculates the sizes AZImgx and AZImgy and the resolutions ARx and ARy of the second original image AZimg using paper sizes Px and Py, a division number N in the vertical and horizontal directions (into N by N divisional images), and magnified amounts EXL, EXR, EXT, and EXB (dots) for enabling marginless printing. The magnified amounts EXL, EXR, EXT, and EXB are magnified amounts from the left end, the right end, the top end, and the bottom end of the paper P, respectively.

The printer driver 13 first calculates sizes AImgx and AImgy of a minimum image, or first original image AImg, required for printing a poster image through marginless printing. The sizes AImgx and AImgy of the first original image AImg are expressed using the paper sizes Px and Py, the division number N, and the magnified amounts EXL, EXR, EXT, and EXB as shown below.
AImgx=N*Px+EXL+EXR
AImgy=N*Py+EXT+EXB

The printer driver 13 then calculates magnification rates ERx (horizontal direction) and ERx (vertical direction) of the first original image AImg with respect to the paper sizes Px and Py. The magnification rates ERx and ERy are calculated as shown below.
ERx=AImgx/Px
ERy=AImgy/Py

The printer driver 13 then calculates sizes AZImgx and AZImgy of a second original image AZImg, which will be provided to the application 12, using the magnification rates ERx and ERx. The sizes AZImgx and AZImgy of the second original image AZImg are calculated as described below.
AZImgx=Px*ExER
AZImgy=Px*ExER

In the above expression, ExER is a larger one of the magnification rates ERx and ERy and is derived using the expression shown below (where max ( ) is a function for calculating a maximum value based on parameters).
ExER=max (ERx, ERy)

More specifically, the sizes AZImgx and AZImgy are calculated according to the aspect ratio of the paper P. The magnification rate ExER corresponds to the magnification rate ER in the first embodiment.

The printer driver 13 further calculates resolutions ARx and ARy of the second original image AZImg, which will be provided to the application 12, using the magnification rate ExER. The resolutions ARx and ARy are calculated based on printing resolutions DRx and DRy corresponding to the print image quality set in step S201 as shown below.
ARx=DRx*ExER
ARy=DRy*ExER

Returning to FIG. 13, in step S205, the application 12 generates the second original image AZImg based on the sizes AZImgx and AZImgy and the resolutions ARx and ARy of the second original image AZImg, which are provided from the printer driver 13.

In step S206, the printer driver 13 calculates sizes ZDiv1x and ZDiv1y and offset coordinates DivOffset [1] (DivOffset [1] is expressed as the offset coordinates ZDIv1Offx and ZDiv1Offy (refer to FIG. 6) in the first embodiment) of the second divisional image ZDiv1 based on the second original image AZImg generated by the application 12. The processing in step S206 will now be described in detail with reference to FIG. 12.

The printer driver 13 first calculates the sizes ZDiv1x and ZDiv1y of the second divisional image ZDiv1 that is to be cut out from the second original image AZImg using the paper sizes Px and Py and the enlargement amounts EXL, EXR, EXT, and EXB as shown below.
ZDiv1x=Px+EXL+EXR
ZDiv1y=Py+EXT+EXB

The printer driver 13 lays out the first original image AImg in a central part of the second original image AZImg. Then, the printer driver 13 calculates the relative positions AOffx and AOffy of the first original image AImg to an origin point position Oa of the second original image AZImg as shown below.
AOffx=(AZImgx−AImgx)/2
AOffx=(AZImgy−AImgy)/2

The printer driver 13 then calculates the offset coordinates DivOffx [1] and DivOffy [1] of the second divisional image ZDiv1 with respect to the origin point position Oa using the relative positions AOffx and AOffy of the first original image AImg as shown below.
DivOffx [I]=AOffx+Px*}(I−1) mod (N)}
DivOffy [I]=AOffy+Py*}(I−1)/N}

In the above expression, {(I−1) mod (N)} is an expression used to obtain a remainder resulting from the division of (I−1) by the division number N. In the expression, I indicates that the image for which the offset is calculated is the Iₜₕ image of the second divisional images ZDiv1, ZDiv2, ZDiv3, and ZDiv4. More specifically, when the offset coordinates DivOff [1] of the second divisional image ZDiv1 is calculated, I is set at 1. In this case, {(I−1) mod (N)}=0 is obtained. As a result, the offset coordinates DivOffx [1] has the same value as the value of the relative position AOffx of the first original image AImg.

Further, in the above expression, ((I−1)/N} is an expression used to calculate a quotient (integer) resulting from the division of (I−1) by the division number N. More specifically, when the offset coordinates DivOff [1] of the second divisional image ZDiv1 is calculated, I is set at 1. In this case, {(I−1) N}=0 is obtained. As a result, the offset coordinates DivOffy [1] has the same value as the value of the relative position AOffy of the first original image AImg.

In this way, the printer driver 13 cuts out the second divisional image ZDiv1 from the second original image AZImg based on the sizes ZDiv1x and ZDiv1y and the offset coordinates DivOffx [1] and DivOffy [1] of the second divisional image ZDiv1. The printer driver 13 performs calculation for the other second divisional images ZDiv2, ZDiv3, and ZDiv4 in the same manner as described above.

Returning to FIG. 13, in step S207, the printer driver 13 lays out the second divisional image ZDiv1 cut out from the second original image AZImg in the printing area ZA (refer to FIG. 5), and generates printing data of the second divisional image ZDiv1. The printer driver 13 then instructs the printer 3 to perform marginless printing.

In step S208, the printer 3 performs marginless printing of the second divisional image ZDiv1 based on the printing data received from the printer driver 13. Afterwards, the printer 3 performs marginless printing of all the second divisional images ZDiv2, ZDiv3, and ZDiv4 based on the printing data received sequentially from the printer driver 13.

The fourth embodiment has the advantages described below.

(1) The printer driver 13 calculates the sizes and the offset coordinates DivOff [1], DivOff [2], DivOff [31, and DivOff [4] of the second divisional images ZDiv1, ZDiv2, ZDiv3, and ZDiv4. As a result, the printer driver 13 performs substantially all the processing required to print a poster image through marginless printing. This increases the versatility of the printer driver as compared with the first embodiment.

It should be apparent to those skilled in the art that the present invention may be embodied in many other specific forms without departing from the spirit or scope of the invention. Particularly, it should be understood that the present invention may be embodied in the following forms.

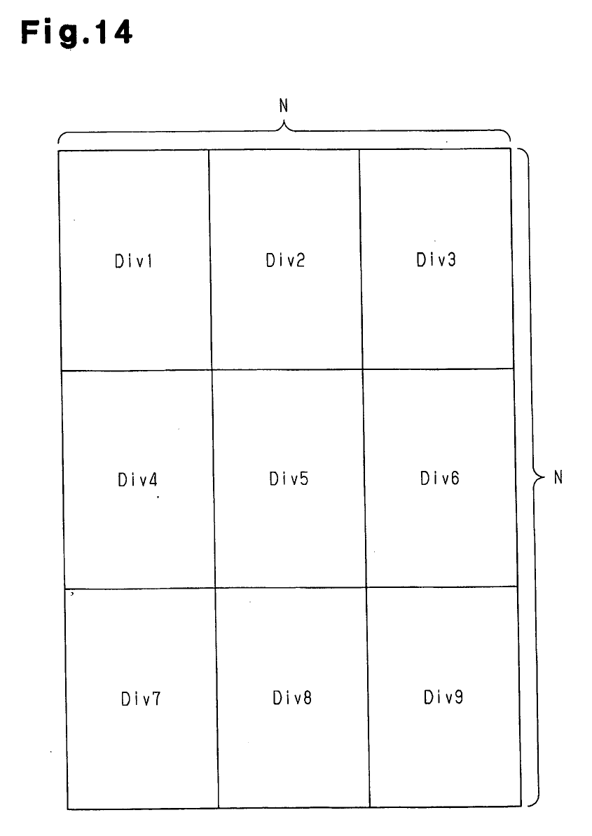

The division number Nd is not limited to four. For example, the division number Nd may be 9 (3 in the vertical direction by 3 in the horizontal direction) as shown in FIG. 14. When the division number Nd is changed to 9 in the fourth embodiment, N is set at 3, and the offset coordinates DivOff [I] of each of the second divisional images ZDiv1, ZDiv2, ZDiv3, ZDiv4, ZDiv5, ZDiv6, ZDiv7, ZDiv8, and ZDiv9 is calculated by substituting I=1 to 9 and N=3 in the above-described expressions for calculating the offset coordinates DivOffx [I] and DivOffy [I].

The printing system 1 may re-print the plurality of divisional images from the beginning when the plural sheets of paper corresponding to the division number are insufficient during printing.

The present examples and embodiments are to be considered as illustrative and not restrictive, and the invention is not to be limited to the details given herein, but may be modified within the scope and equivalence of the appended claims.

What is claimed is:

1. A printing system for forming a poster image corresponding to a first original image by performing marginless printing on plural sheets of paper, the paper having a predetermined size, the printing system comprising:
a printing area setting unit for setting a printing area by magnifying the size of the paper by a predetermined magnification rate;
an image generating unit for magnifying the first original image by the predetermined magnification rate to generate a second original image and for generating a plurality of divisional images from the second original image using the first original image, a division number by which the first original image is divided, and the magnification rate;
an image layout unit for laying out each of the plurality of divisional images in the printing area; and
a printing control unit for generating printing data for each of the plurality of divisional images laid out in the printing area so that the center of each of the divisional images is substantially aligned with the center of the paper to which the divisional image is to be printed.

2. The printing system according to claim 1, wherein the image generating unit divides the first original image by the division number to generate a plurality of first divisional images and magnifies each of the plurality of first divisional images by the magnification rate to generate a plurality of second divisional images respectively corresponding to the plurality of divisional images from the second original image.

3. The printing system according to claim 1, further comprising:
a printer, wherein the magnification rate is set based on an overhang amount for the marginless printing taking into account mechanical misalignment of the printer.

4. The printing system according to claim 1, wherein:
the printing area setting unit calculates printing position information including the size of the printing area and first offset coordinates indicating the position of the printing area;
the image generating unit calculates layout information including the size of each of the plurality of divisional images and second offset coordinates indicating the position of each of the plurality of divisional images; and
the image layout unit lays out each of the plurality of divisional images in the printing area based on the printing position information and the layout information.

5. The printing system according to claim 1, further comprising:
a computer; and
a printer connected to the computer;
wherein the computer includes a printer driver for controlling operation of the printer and an application for aiding generation of the poster image;
the application functioning as part of the image generating unit and generating the second original image from the first original image using the first original image and the magnification rate; and
the printer driver functioning as part of the image generating unit, the printing area setting unit, the image layout unit, and the printing control unit, and generating the plurality of divisional images from the second original image using the first original image, the division number, and the magnification rate when functioning as part of the image generating unit.

6. The printing system according to claim 5, wherein:
the printer driver calculates the size and the resolution of the second original image based on the division number, the size of the paper, the magnification rate, and a printing resolution set for the printer; and
the application retrieves the size and the resolution of the second original image from the printer driver to generate the second original image.

7. The printing system according to claim 1, wherein the poster image is printed so as to form a single poster image with plurality sheets of the paper, with at least one of the plural sheets of paper having a side on which a margin is formed and a side on which no margin is formed.

8. The printing system according to claim 1, wherein:
the plurality of divisional images are respectively printed on the plural sheets of paper corresponding to the division number; and
when the sheets of paper are insufficient during printing, the printing control unit re-prints the plurality of divisional images from the beginning.

9. A method for forming a poster image corresponding to a first original image by performing marginless printing on plural sheets of paper, the paper having a predetermined size, the method comprising:
setting a printing area by magnifying the size of the paper by a predetermined magnification rate;
magnifying the first original image by the predetermined magnification rate to generate a second original image;
dividing the first original image by a division number that is greater than or equal to two to generate a plurality of first divisional images;
magnifying each of the plurality of first divisional images by the magnification rate to generate a plurality of second divisional images from the second original image;
laying out each of the plurality of second divisional images in the printing area; and
generating printing data for each of the plurality of divisional images laid out in the printing area so that the center of each of the divisional images is substantially aligned with the center of the paper to which the divisional image is to be printed.

10. An image processor comprising:
an original image retrieval unit for retrieving an original image;
an output image generation unit for generating a predetermined number of output images from the retrieved original image; and
a printing control unit for printing each of the output images on a predetermined sheet of paper, with each output image being larger than the sheet of paper and having a center that is substantially aligned with the center of the sheet of paper, wherein each of the output images corresponds to a divisional image generated by dividing the original image by a predetermined number and includes the corresponding divisional image.
